(19) United States
(12) Patent Application Publication
(10) Pub. No.: US 2005/0275667 A1
(43) Pub. Date: Dec. 15, 2005

(54) Multi-display system method of controlling the same

(76) Inventor: Joo-Hee Jeon, Seoul (KR)

Correspondence Address: STANZIONE & KIM, LLP, 919 18TH STREET, N.W., SUITE 440, WASHINGTON, DC, 20006, US

(21) Appl. No.: 11/148,408

(22) Filed: Jun. 9, 2005

(30) Foreign Application Priority Data
Jun. 11, 2004 (KR) 2004-43220

(51) Int. Cl. G09G 5/00

(52) U.S. Cl. 345/684; 345/686

(57) ABSTRACT

A multi-display system having a plurality of display apparatuses, the multi-display system including a host device including a scroll configuration part setting a scroll function to scroll a screen of each display apparatus and a host communication interface part communicating with each of the plurality of display apparatuses, and transmitting a control signal to a corresponding display apparatus through the host communication interface part when the scroll configuration part sets the scroll function; a display communication interface part provided in the respective display apparatuses; and a display controller provided in the respective display apparatuses and controlling a corresponding screen to be scrolled according to the control signal transmitted from the host device through the display communication interface part. With this configuration, a multi-display system and method of controlling the same to efficiently prevent an afterimage from being generated on a plurality of display apparatuses can be provided.

### CROSS-REFERENCE TO RELATED APPLICATIONS

This application claims the benefit of Korean Patent Application No. 2004-43220, filed on Jun. 11, 2004, in the Korean Intellectual Property Office, the disclosure of which is incorporated herein in its entirety and by reference.

### BACKGROUND OF THE INVENTION

1. Field of the Invention

The present general inventive concept relates to a multi-display system and a method of controlling the same, and more particularly, a multi-display system and a method of controlling the same to efficiently remove afterimages generated on a plurality of display apparatuses.

2. Description of the Related Art

Recently, an airport or a train station serves various information, such as a flight schedule or departure/arrival times of trains, using a plurality of display apparatuses such as a liquid crystal display (LCD) monitor or a plasma display panel (PDP) monitor. These kinds of display apparatuses are designed as a vertical market business (VMB) model. Unlike a display apparatus designed for a personal purpose, these VBM display apparatuses display or update information every day and every night. These VBM display apparatuses sometimes display a moving picture for an advertising purpose, but mostly display information about finance, hotel facilities, or flight schedules, etc. Herein, an afterimage may be generated when displaying the same screen or the same information for a comparatively long period of time.

### SUMMARY OF THE INVENTION

Accordingly, the present general inventive concept provides a multi-display system and method of controlling the same to efficiently remove an afterimage generated on a plurality of display apparatuses.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept are also achieved by providing a multi-display system comprising: a plurality of display apparatuses, comprising a host device comprising a scroll configuration part setting a scroll function to scroll a screen of each display apparatus and a host communication interface part communicating with each of the plurality of display apparatuses, and transmitting a control signal to a corresponding display apparatus through the host communication interface part when the scroll configuration part sets the scroll function; a display communication interface part provided in the respective display apparatuses; and a display controller provided in the respective display apparatuses and controlling a corresponding screen to be scrolled according to the control signal transmitted from the host device through the display communication interface part.

According to an embodiment of the present general inventive concept, the respective display apparatuses may further comprise a screen capturer capturing the corresponding screen and a scroll scrolling the screen captured by the screen capturer, the display controller controls the screen capturer and the scroll to capture and scroll the corresponding screen in accordance with the control signal transmitted from the host device through the display communication interface part.

According to an embodiment of the present general inventive concept, the scroll configuration part can set the scroll function by an interval and duration of execution to scroll the screen.

The foregoing and/or other aspects and advantages of the present general inventive concept are also achieved by providing a control method of a multi-display system comprising: a plurality of display apparatuses, comprising setting a scroll function to scroll each screen of the plurality of display apparatuses from a host device; transmitting a control signal from the host device to a corresponding display apparatus when the scroll function is set; and scrolling an associated screen of the corresponding display apparatus receiving the control signal from the host device.

According to an embodiment of the present general inventive concept, the scrolling of an associated screen may further comprise capturing the associated screen of the corresponding display apparatus receiving the control signal from the host device; and scrolling the captured screen by the capturing.

According to an embodiment of the present general inventive concept, the setting of the scroll function may further comprise setting the scroll function by an interval and duration of execution to scroll the screen.

### BRIEF DESCRIPTION OF THE DRAWINGS

The above and/or other aspects and advantages of the present general inventive concept will become apparent and more readily appreciated from the following description of the embodiments, taken in conjunction with the accompany drawings of which:

FIG. 1 is a control block diagram of a multi-display system according to an embodiment of present general inventive concept;

FIG. 2 shows an exemplary interface to set a scroll function therethrough, according to an embodiment of the present general inventive concept; and

FIG. 3 is a control flow of a multi-display system according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below in order to explain the present general inventive concept by referring to the figures.

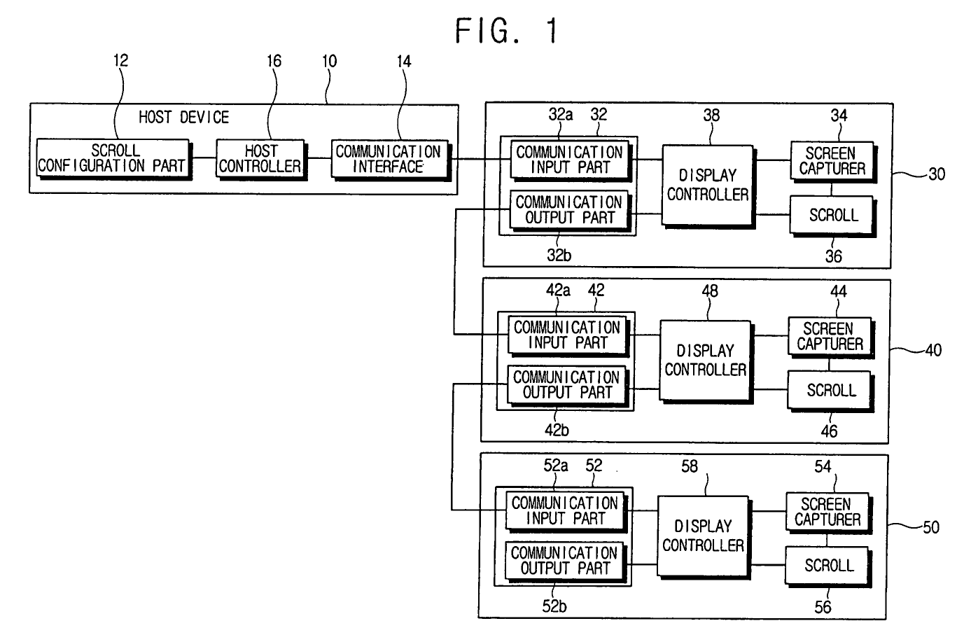

FIG. 1 is a control block diagram of a multi-display system according to an embodiment of the present general inventive concept. As shown in FIG. 1, the multi-display system may comprise: a host side including a host device 10 comprising a scroll configuration part 12, a communication interface 14 and a host controller 16; and a display side including a plurality of display apparatuses 30, 40 and 50 (hereinafter, a first, second and third display apparatus) respectively comprising a communication interface 32, 42 and 52, a screen capturer 34, 44 and 54 capturing a screen, a scroll 36, 46 and 56 scrolling the captured screen; and a display controller 38, 48 and 58.

The communication interface 14 at the host side, and the communication interfaces 32, 42 and 52 at the display apparatus side generally adopt the RS-232C interface. Other wired/wireless interface can also be adopted.

The communication interfaces 32, 42 and 52 (hereinafter referred to as first, second and third communication interfaces) at the display apparatus side respectively comprise: a first communication input part 32a, a second communication input part 42a and a third communication input part 52a to receive communication data from an external device; and a first communication output part 32b, a second communication output part 42b and a third communication output part 52b to transmit the communication data input through the respective first, second and third communication input parts 32a, 42a and 52a to an external device. The first communication input part 32a can be connected to the communication interface 14 at the host side and can receive the communication data directly from the host device 10, whereas the first communication output part 32b, which is associated with the first communication input part 32a of the first display apparatus 30, can be connected to the second communication input part 42a. Further, the second communication output part 42b of the second display apparatus 40 can be connected to the third communication input part 52a of the third display apparatus 50. Therefore, the first, second and third display apparatuses 30, 40 and 50 can be connected by a loop-out RS232C circuit.

However, the embodiment shown in FIG. 1 of the present general inventive concept is not limited to the foregoing configurational structure. For example, the host device 10 and the display apparatuses 30, 40 and 50 may communicate with each other through various alternative configurational structures.

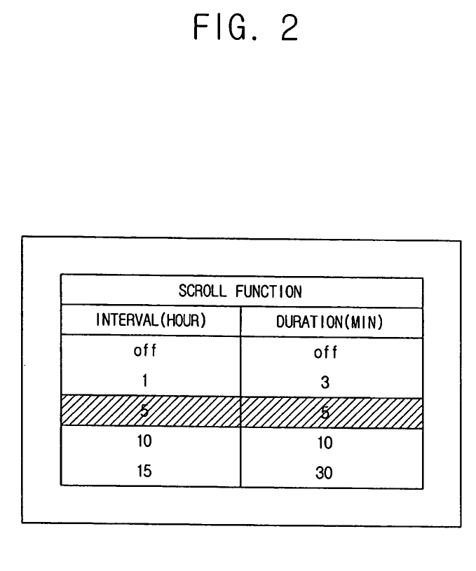

The scroll configuration part 12 sets a scroll function of a screen of the first, second and third display apparatuses 30, 40 and 50, and may be provided as a given program executed on the basis of an operating system, but is not limited thereto. The host device 10 executes the given program to set the scroll function through an interface as shown in FIG. 2. However, FIG. 2 shows an exemplary interface to set the scroll function according to an embodiment of the present general inventive concept, and thus is not limited thereto. The scroll function can be set by an interval and a duration of execution to scroll the screen, as shown in FIG. 2. The interval and the duration of execution of the scroll function may be set differently depending on the display apparatus or apparatuses. Meanwhile, the interface to set the scroll function may be popped up on a screen by pressing a button or a key to execute the program.

The host controller 16 transmits a control signal to the respective display apparatuses 30, 40 and 50 through the communication interface 14 to scroll a corresponding screen according to the interval and duration of execution set through the scroll configuration part 12. Herein, the host controller 16 controls a corresponding display apparatus on the basis of IDs (Identification) which is respectively assigned to the first, second, and third display apparatuses 30, 40 and 50. The host controller 16 may control all of the display apparatuses 30, 40 and 50, or some of them depending on a configuration state set through the scroll configuration part 12.

The screen capturers 34, 44 and 54 capture a screen when the scroll function is set through the scroll configuration part 12, and may comprise a scaler integrated circuit (IC), but is not limited thereto.

The scrolls 36, 46 and 56 move the screen captured by the respective screen capturers 34, 44 and 54 per line to execute the scroll function. The scroll function is commonly used in a personal computer, and shifts the captured screen about a given data on the basis of a vertical or horizontal synchronized signal to scroll the screen of the personal computer up or down, or left or right.

The display controller 38 can check whether the control signal of the host device 10 input through the first communication input part 32a corresponds to the first display apparatus 30. If the input control signal does not correspond with the first display apparatus 30, the first display controller 38 transmits the control signal to the second display apparatus 40 through the first communication output part 32b. Then, the second display controller 40 can check whether the transmitted control signal corresponds with the second display apparatus 40, and transmits the control signal to the third display apparatus 50 through the second communication output part 42b if the control signal does not correspond with the second display apparatus 40. Meanwhile, if control signal input through each of the first, second and third input parts 32a, 42a and 52a corresponds with one of the first, second and third display apparatuses 30, 40 and 50, an associated display controller 38, 48 and 58 controls an associated screen capturer 34, 44 and 54 and an associated scroll 36, 46 and 56 to scroll an associated screen.

Thus, even though the display apparatus(es) displays the same screen or the same information for a long time period, the screen is set through the scroll configuration part 12 to scroll per line for a set duration at a set interval so as to prevent an afterimage.

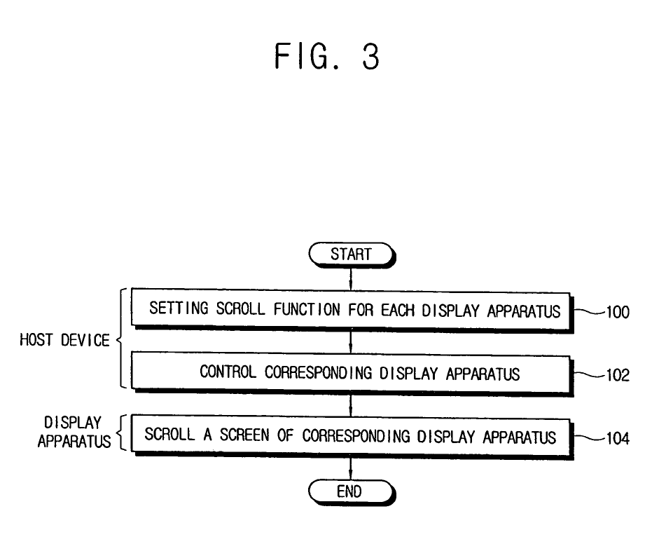

FIG. 3 shows a flow chart of the multi-display system with the foregoing configurations according to the present general inventive concept.

First, scroll functions for each of the first, second and third display apparatuses 30, 40 and 50 are set through the scroll configuration part 12 of the host device 10, at operation S100. The host controller 16 transmits a control signal to a corresponding display apparatus 30, 40 and 50 according to a configuration state of scroll function set through the scroll configuration part 12, at operation S102. Thus, one or more of the display controllers 38, 48 and 58 associated with the corresponding display apparatus 30, 40 and 50 controls an associated screen capturer 34, 44 and 54 and an associated scroll 36, 46 and 56 to scroll an associated screen, at operation S104.

According to the foregoing embodiment, the number of display apparatuses communicating with the host apparatus may comprise first, second and third display apparatuses, but the number of display apparatuses is not limited thereto.

Also, the first display controller according to the foregoing embodiment sequentially checks whether the control signal inputted through the communication input part directly connected to the host device corresponds to the first display apparatus. If the input control signal does not correspond to the first display apparatus, the first display controller transmits the control signal to the second display apparatus through the first communication output part connecting the first display apparatus and the second display apparatus. Similarly, if the input control signal does not correspond to the second display apparatus, the second display controller transmits the control signal to the third display apparatus through the second communication output part connecting the second display apparatus and the third display apparatus. Alternatively, the control signal may be directly transmitted to all of the display apparatuses without passing through the checking process of the display controller.

As described above, the embodiments of the present general inventive concept can prevent an afterimage from being generated when the same screen or the same information is displayed for a long time period by setting the scroll function from the host device so as to scroll the corresponding screen of the plurality of display apparatuses communicating with the host device.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A multi-display system having a plurality of display apparatuses, comprising:
a host device comprising a scroll configuration part setting a scroll function to scroll a screen of each display apparatus and a host communication interface part communicating with each of the plurality of display apparatuses, and transmitting a control signal to a corresponding display apparatus through the host communication interface part when the scroll configuration part sets the scroll function;
a display communication interface part provided in the respective display apparatuses; and
a display controller provided in the respective display apparatuses to control a corresponding screen to be scrolled according to the control signal transmitted from the host device through the display communication interface part.

2. The multi-display system according to claim 1, wherein each of the respective display apparatuses further comprise a screen capturer to capture the corresponding screen and a scroll to scroll the screen captured by the screen capturer,
the display controller controls the screen capturer and the scroll to capture and scroll the corresponding screen in accordance with the control signal transmitted from the host device through the display communication interface part.

3. The multi-display system according to claim 1, wherein the scroll configuration part sets the scroll function by an interval and duration of execution to scroll the screen.

4. The multi-display system according to claim 2, wherein the scroll configuration part sets the scroll function by an interval and duration of execution to scroll the screen.

5. A control method of a multi-display system having a plurality of display apparatuses, the method comprising:
setting a scroll function to scroll each screen of the plurality of display apparatuses from a host device;
transmitting a control signal from the host device to a corresponding display apparatus when the scroll function is set; and
scrolling an associated screen of the corresponding display apparatus receiving the control signal from the host device.

6. The control method according to claim 5, wherein the scrolling the corresponding screen comprises:
capturing the associated screen of the corresponding display apparatus receiving the control signal from the host device; and
scrolling the captured screen by the capturing.

7. The control method according to claim 5, wherein the setting the scroll function comprises setting the scroll function by an interval and duration of execution to scroll the screen.

8. The control method according to claim 6, wherein the setting the scroll function comprises setting the scroll function by an interval and duration of execution to scroll the screen.

9. A multi-display system to control a plurality of display units, comprising:
a host device including:
a scroll configuration part to generate a program to set scroll operations of a screen for each of the plurality of display units, and
a host controller to transmit a control signal to perform the scroll operations on predetermined ones of the screens of the respective display units based on the program generated by the scroll configuration part; and
a display control system to receive the control signal from the host controller and to control the predetermined ones of the screens of the display units to be scrolled based on the received control signal.

10. The multi-display system according to claim 9, wherein the display control system comprises a display controller associated with each of the display units to control the respective display unit to be scrolled based on the received control signal.

11. The multi-display system according to claim 10, further comprising:
a host communication interface to transmit the control signal generated by the host controller; and
a display communication interface to receive the transmitted control signal and supply the control signal to the display controllers.

12. The multi-display system according to claim 9, wherein the predetermined ones of the screens are controlled to be scrolled based on an identification (ID) assigned to each of the respective display units.

13. The multi-display system according to claim 11, wherein the predetermined ones of the screens are controlled to be scrolled based on an identification (ID) assigned to each of the respective display units.

14. The multi-display system according to claim 13, wherein each of the respective display units further comprise a screen capturer to capture the associated screen and a scroll to scroll the screen captured by the screen capturer, and the associated display controller controls the screen capturer and the scroll to capture and scroll the corresponding screen in accordance with the control signal transmitted from the host device through the display communication interface part.

15. The multi-display system according to claim 14, wherein the scroll configuration part sets the scroll operation by an interval and duration of execution to scroll the screen.

16. A multi-display system to control a plurality of display units, comprising:
a host device to transmit control signals to control scrolling operations of a plurality of display units; and
a plurality of display units, each display unit including a display controller to receive the control signals from the host device, to determine whether the control signals correspond to an associated screen and to control scrolling operations of the associated screen based on the determination, a communication interface to receive and forward the control signal to the associated display controller, and to transmit the control signal to another one of the plurality of display units if the display controller determines that the control signal does not correspond with the associated screen.

17. The multi-display system according to claim 16, wherein the host device comprises:
a scroll configuration part to generate a program to set scroll operations of a screen for each of the plurality of display units; and
a host controller to transmit the control signals to perform the scroll operations on the screens of the respective display units based on the program generated by the scroll configuration part.

18. The multi-display system according to claim 17, wherein the display controller determines whether the control signals correspond to an associated screen based on a comparison of IDs of the display units and the received control signals.

19. The multi-display system according to claim 17, wherein each of the respective display units further comprise a screen capturer to capture the associated screen and a scroll to scroll the screen captured by the screen capturer, and the associated display controller controls the screen capturer and the scroll to capture and scroll the corresponding screen in accordance with the control signal transmitted from the host device.

20. The multi-display system according to claim 19, wherein the scroll configuration part sets the scroll operation by an interval and duration of execution to scroll the screen.

21. A method of controlling a multi-display system having a plurality of display devices, comprising:
transmitting a control signal to predetermined ones of the plurality of display devices to perform scroll operations on an associated screen, the scroll operations being provided as a program executed on the basis of an operating system; and
scrolling the predetermined screens receiving the transmitted control signal.

22. The method according to claim 21, wherein the scrolling the predetermined screen comprises:
capturing the associated screen of the corresponding display device receiving the control signal; and
scrolling the captured screen.

23. The method according to claim 22, wherein the scrolling operations comprise setting the scroll function by an interval and duration of execution to scroll the predetermined screen.
